(19) United States
(12) Patent Application Publication
(10) Pub. No.: US 2002/0194272 A1
(43) Pub. Date: Dec. 19, 2002

(54) Method for establishing a communication connection between two or more users via a network of interconnected computers

(76) Inventor: Min Zhu, Los Altos Hills, CA (US)

Correspondence Address: Fish & Richardson P.C., 500 Arguello Street, Suite 500, Redwood City, CA, 94063, US

(21) Appl. No.: 09/569,760

(22) Filed: May 12, 2000

Related U.S. Application Data
(63) Continuation of application No. 09/195,801, filed on Nov. 18, 1998, now abandoned.
(60) Provisional application No. 60/065,664, filed on Nov. 18, 1997.

(51) Int. Cl. G06F 15/16

(52) U.S. Cl. 709/204

(57) ABSTRACT

A method for establishing a communication link between two or more users via the Internet, and, more specifically, a web-server based real-time data conferencing system, is disclosed. Under the presently implementation, a user uses an application (such as a web browser) to retrieve and view a web page. On the web page (or the like), a clickable icon or hyperlink is provided to call another user or service. At this time, there is no custom software on the user/caller side. However, the hyperlink can activate a subprogram to gather certain types of information of interest to pass to the server to tailor a response; it can also perform any other tasks as necessary. The server (call-center software), upon receiving the request to establish a connection, determines an agent to receive the call and activate any related software thereof. In the presently implementation, the call center processes the request and activates an application on the agent's machine to establish the connection. More specifically, it causes the agent's web browser to be launched if it is not already launched and it provides a customized web page to the caller if appropriate. In the next step, now having established a connection between the caller and an agent, a collaboration software can be activated to allow better communication between the two parties. This collaboration software can be a chat program, a white board program, Internet phone, or any other communication software. Under this paradigm, the caller does not need any software to establish a connection with an agent who has the necessary software for receiving and processing the call.

This application is a continuation of parent application U.S. Ser. No. 09/195,801, filed Nov. 18, 1998, which takes its priority from provisional application U.S. serial No. 60/065,664, filed Nov. 18, 1997. The disclosure thereof is incorporated herein by reference.

### BACKGROUND

The present invention relates generally to methods for establishing a communication channel between two or more users.

Under the concepts and software applications of the prior art, two users wishing to communicate over the Internet (or any other communication link) would have to arrange a meeting time and an agreed upon mode of communication, or that one party would have to always wait for the other party to call. These models are inefficient in that time has to be spent in arranging the meetings and that they do not allow spontaneous calling of another user over the communication links.

In another real model, the call center model, customers call a typically toll free number for service or inquiry on a given product or service. For example, a customer can call a toll-free number for an insurance company to inquire about an insurance quote, and the customer will then be routed to an available service representative. If no representative is available, the customer will be placed on hold for the next available representative. Once a representative becomes available, the customer is connected to the representative. This real life model is an efficient model based on the telephone network. However, with the advent of the Internet, the telephone network has become an out-of-date model.

### SUMMARY OF THE INVENTION

It would be desirable to have an Internet based call center model for handling calls from a number of customers “calling” from their computer terminals or a telephone equivalent call from one user to another user through the Internet.

One implementation of the present invention provides a method for establishing a communication link between two or more users via the Internet, and, more specifically, a web-server based real-time data conferencing system. Under one implementation, a user uses an application (such as a web browser) to retrieve and view a web page or the like. On the web page, a clickable icon or hyperlink is provided to call another user or service. At this time, there is no custom software is required on the user/caller side. However, the hyperlink can activate a subprogram to gather certain types of information of interest to pass to the server to tailor a response; it can also perform any other tasks as necessary. The server (call-center software), upon receiving the request to establish a connection, determines a member to receive the call and activates any related software. In the present implementation, the call center processes the request and activates an application on the member's machine to establish the connection. More specifically, it causes the member's web browser to be launched if it is not already launched and it provides a customized web page to the caller if appropriate. In the next step, now having established a connection between the caller and a member, a collaboration software can be activated to allow better communication between the two parties. This collaboration software can be a chat program, a white board program, Internet phone, or any other communication software.

Under this paradigm, the caller does not need any client software, other than the browser, to establish a connection with a member who has the necessary software for receiving and processing the call. This paradigm is particularly helpful in service and/or sales types of activities where a customer inquiry can be answered in a chat session over the Internet without requiring the customer to have any software to begin with.

The caller can also download the call-center supported software onto the caller's machine. As long as the software is running at a connection that can be determined and be reached by the call-center software, anyone can request a connection with this particular caller and be connected to this particular caller. Thus, this model is very much like the ubiquitous telephone at every household. As long as the phone is connected and is not off-hook, another party can call in and be connected when answered. Even if one party is not available at a particular time, the calling party can be recorded and notified to the receiving party when the receiving party comes on-line.

The present invention features a method and computer program product for establishing a conference over the Internet.

According to one implementation, the method includes providing on a web page a link for establishing a conference between two or more users; linking a browser running on a guest computer with a web server upon activation of the link by a guest using the guest computer; assigning a member for conferencing with the guest, the member having a member computer running a member browser; and linking the member browser with the web server for conferencing.

According to one aspect, the method includes delivering collaboration software to the guest computer; wherein the guest browser and member browser conference using the collaboration software.

According to one aspect, the collaboration software includes a text exchange tool, a whiteboard tool, and an application sharing tool.

According to one aspect, assigning includes gathering information regarding the guest from the guest computer; and selecting a member based on the information for conferencing.

According to one aspect, assigning includes receiving a request from the guest to conference with a specific member; and selecting the specific member for conferencing.

According to one aspect, the conference is a real-time conference.

According to one aspect, the collaboration software includes an Internet telephone, and the linking includes establishing an Internet phone connection between the guest browser and the member browser.

According to one aspect, the method includes encrypting communications between the guest and the member.

According to another implementation, the method includes providing on a web page a link for establishing a conference between two or more users; linking a browser running on a guest computer with a web server upon activation of the link by a guest using the guest computer; assigning a member for conferencing with the guest; and establishing a telephone connection between the member and the guest.

These and other features and advantages of the present invention will become well understood upon examining the figures and reading the following detailed description of the invention.

### DRAWINGS

FIG. 1 illustrates a diagram showing the collaborating systems and the various components thereof.

FIG. 2 illustrates a block diagram of a web server interface of the implementation.

FIGS. 3a and 3b illustrate examples of web server interfaces.

FIG. 4 illustrates a server architecture of an implementation.

FIG. 5 illustrates a block diagram of data collaboration services.

FIG. 6 illustrates a block diagram of a session manager.

FIG. 7 illustrates a block diagram of an intelligent routing server.

FIG. 8 illustrates a block diagram of a web client manager.

FIG. 9 illustrates a call center environment diagram.

FIG. 10 illustrates an implementation of the communication stack architecture of the present invention.

FIG. 11 illustrates a typical running topology.

FIG. 12 illustrates an implementation of the system flow of the present invention.

FIG. 13 illustrates an implementation of the MP Connect Request.

FIG. 14 illustrates an implementation of the MCU communication domain.

### DETAILED DESCRIPTION OF THE IMPLEMENTATION

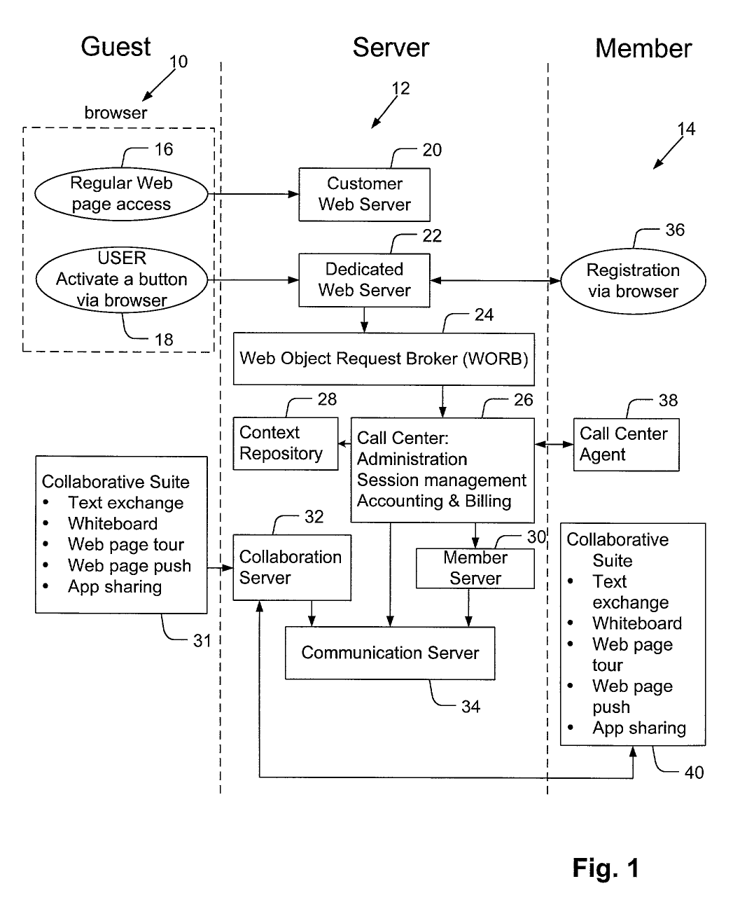

Referring to FIG. 1, a block diagram divided into three sections, a guest section 10, a server section 12, and a member section 14 is provided to illustrates the three collaborating systems and the various components provided therein. The guest section 10 can be considered as the computer system being used by a guest (also referred to as a customer or user). In the guest section 10, a guest activates an application of the implementation through a regular web page 16 or activates a button to activate the application via a browser 18. The browser can be a commercially available browser or a custom browser provided specifically for the current task. At the guest section 10, there can be also a suite of collaboration software including applications such as a text exchange (chat) program, a whiteboard program, a web page tour program, a web page push program, an application sharing program, and the like. These programs can be downloaded real-time from a server upon request.

In the server section 12, there can be a customer web server 20 for handling regular web page access. There can also be a dedicated server 22 for the handling the processing steps of the present implementation. In this dedicated server 22, there can be a web object request broker 24 for handling the various types of requests. For a call center request, the request is routed to a call center 26 which provides administration of the incoming calls, for managing the various sessions between a guest and a call center member (e.g., a registered member), and for tracking accounting related issues such as time and billing. For call center types of requests, the call center 26 provides data from a context repository 28 which in turn provides dynamic or static data associated with the request, which is associated with a particular hyperlink. In other words, customized data can be provided to the guest depending on the particular request. The call center 26 interacts with a member server 30 which manages a number of members, each performing a pre-programmed task such as configuration verification, virus check, etc. There is also a communication server 34, interacting with a collaboration server 32, for connecting multiple users through the collaboration applications indicated at 31 and 40.

For the member section 14, which are the computer systems for the users being connected to, there is a registration component 36 for registering guests/users. At this section, there are one or more call center members (registered members) for connecting by the call center 26 to a guest. Generally speaking, these call center agents are software providing an interface to allow a person to communicate to the guest via the collaborative applications 40.

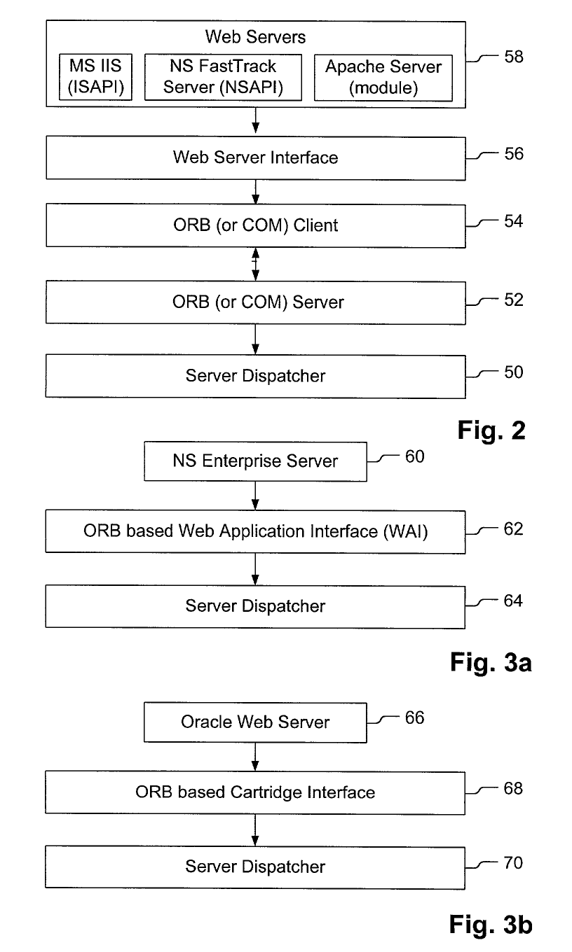

FIG. 2 illustrates the interface scheme of the web object request broker 24 of FIG. 1. Here, the server dispatcher 50 connects to the call center (FIG. 1, 26) on one side and connects to an object request broker on the other side 52. The object request broker 52 communicates to the object request broker 54 of a web server interface 56 for communication with web servers 58. The web server can be any one of the commercially available servers from a number of sources. This figure illustrates a manner for the call center (FIG. 1, 26) to communicate with the web servers.

FIGS. 3a and 3b illustrate two examples of different web server interfaces of FIG. 2. FIG. 3a illustrates the use of an NS Enterprise Server 60 interfacing with an object request broker (ORB)-based web application interface 62 to the server dispatcher 64 (FIG. 2, 50). FIG. 3b illustrates an Oracle Web Server 66 interfacing with an ORB-based cartridge interface 68 to the server dispatcher 70 (FIG. 2, 50).

In operation, certain buttons on a web page are provided and associated with the application software of the implementation. The web page can be part of a secured web site requiring a password for access. The activation process can also be provided through the activation of an application on the user's machine. Upon activation, a communication link to the Internet is provided to carry out a method of the present invention. More specifically, the server of a method of the present invention (server section of FIG. 1) takes over and sends a message to one or more registered members (or call center members) on the receiving side (member section of FIG. 1) to signal that there is a guest waiting to be connected.

Depending on the mode of operation, a registered member can decide to answer the signal or refuse the signal. In this manner, this is a model like a telephone, which the receiving person can decide to answer the call or refuse the call. In a call center model, the registered member can not have a choice and can have to answer the call. At the time of the connection, the system can offer the choices for a phone connection (through Internet phone or regular phone) or provide information from a database regarding the guest. A live data connection between the guest and the registered member can be set up through the use of collaboration software such as a chat program, a whiteboard, web page navigation, push technology programs and the like. At this time, there is a real-time conference. Optionally, the system can allow other guests or registered members to join this conference. Call center members or registered members are users that have registered with the system as being available for connection to other guests or registered members and therefore can be “called” by other people. A guest without application software of the implementation cannot be called by others and can only call registered members. The above-described method provides the capability for real-time connection to a database where information regarding a guest can be readily retrieved and shown to the registered member prior to connecting to the guest. Additionally, a guest can request a specific registered member for connection rather than being randomly assigned.

Other features of the implementation include ready connection to the telephone network where the guest can be directly connected to a registered member for a live conversation. This can be achieved through the use of a second modem on the guest side or the registered member's side for direct dialing to the other side. In one implementation a guest need not have any specialized software on its machine. In an alternative implementation, the guest can download a guest agent for receiving and identifying incoming or outgoing calls.

With the use of a database, transactions can be recorded and automated. For example, a registered member can set a reminder in the database for reminding the registered member with regard to a particular transaction over a particular item of interest with a particular guest. This reminder can be set in the transaction database or the database for the item of interest. In this manner, potential sales leads can be tracked and followed up.

The above-described implementations can be further customized to tailor to specific applications. For example, in one application, referred to herein as an active meeting, the application can be tailored to be a specific conferencing application where guests and/or registered members select a designated registered member as the agreed meeting place. A real-time interactive chat session can be provided such that everyone can interact.

In another application, referred to herein as active connections, the application can be tailored to be a commerce application where guests visiting can be directly connected to a randomly-selected, guest-requested, or best-fit service representative (registered member). In the best-fit situation, the guest can answer a number of questions generally describing the request or problem. An intelligent database subsystem can examine the answers and determine the most qualified representative for this particular guest.

In the guest-requested service representative situation, a list of service representatives is provided to the guest. Upon selecting a particular service representative, the guest is connected to the particular service representative via the TCP/IP address of the service representative. In this application, if appropriate and available, guest information can be readily retrieved from the database and provided to the registered member as background information. Furthermore, the guest can be allowed access to a number of databases, including a scheduling database for scheduling with a particular service representative (registered member) or to retrieve and enter information into a database. In yet another application, a registered member can call up a guest, through the use of a guest agent at the user/guest side, and interact with the guest.

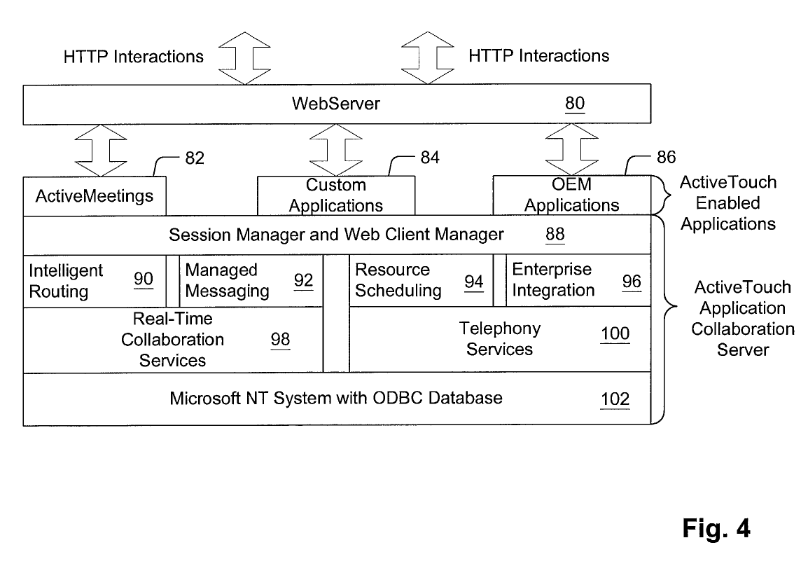

FIG. 4 illustrates one server architecture implementation. Here, the interface to the web is through a web server 80. The web server 80 interacts with a number of components, including an active meeting component 82, any custom applications 84, or OEM applications 86. A session manager and web client manager 88 interface and interact on one side with active meeting applications, custom applications, and OEM applications, and interface and interact with an intelligent routing component 90, a managed messaging component 92, a resource scheduling component 94, and an enterprise integration component 96. All of these components interact with real-time collaboration services 98 and telephony services 100, which rest on an operation system and database 102.

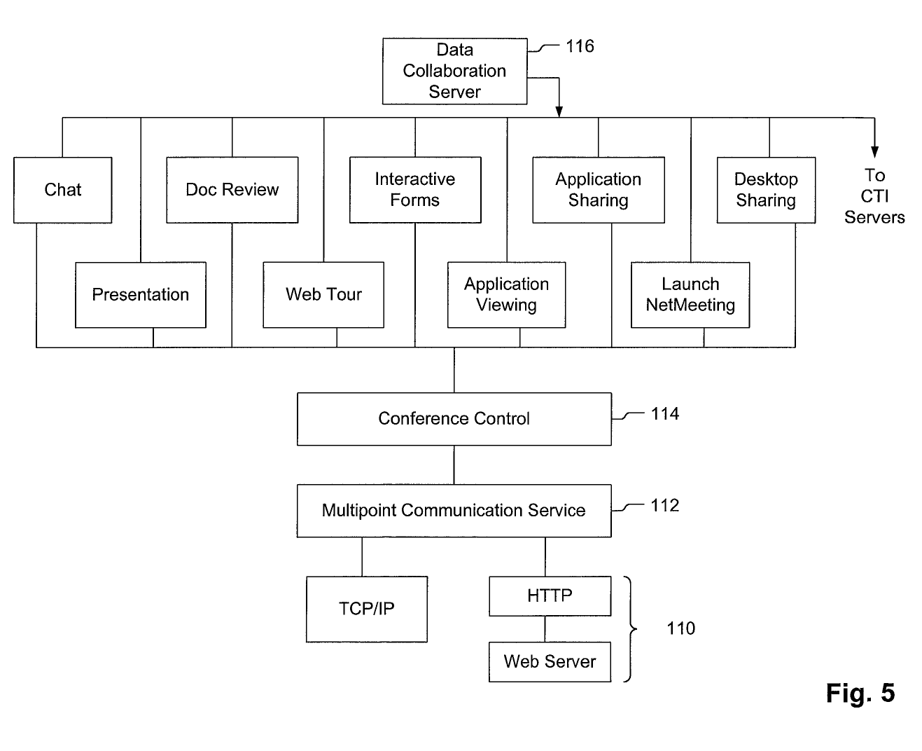

Referring to FIG. 5, further describing data collaboration services of the implementation, Internet protocol based data and servers 110 interfaces with a multi-point communication service 112 for interfacing a number of guests and registered members. Conference control 114 properly routes and controls access to various services, including chat programs, presentation programs, document review programs, web tour programs, interactive forms programs, viewer programs, application sharing programs, netmeeting program, desktop sharing programs, and the like, all of which, in one aspect, can access data from the data collaboration server 16 and in another aspect access CTI servers.

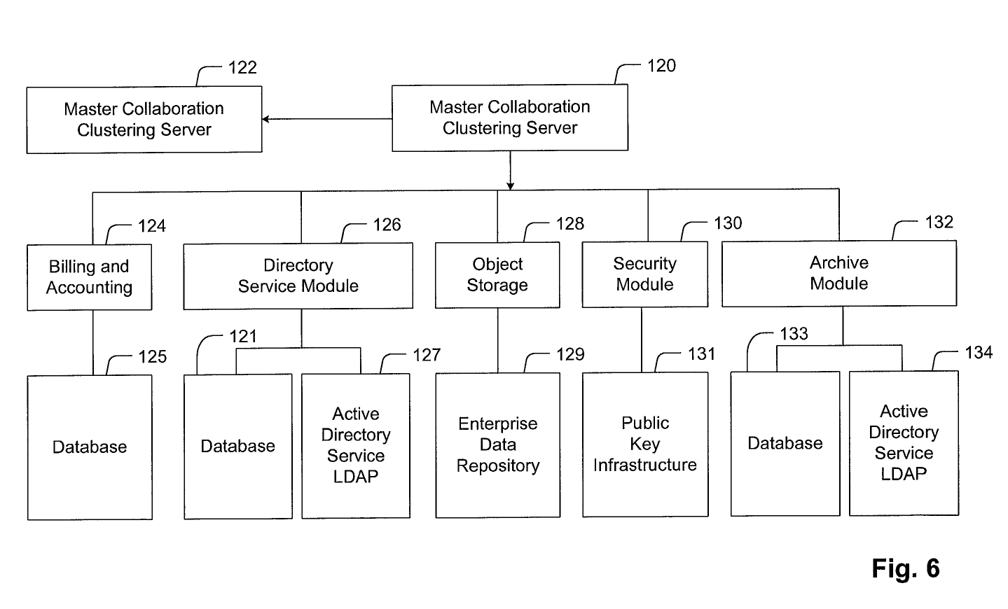

FIG. 6 illustrates a session manager, which can be part of the call center or member server of FIG. 1. Here, the session manager interfaces with a master collaboration clustering server 122 and manages a billing and accounting module 124 and database 125, a directory service module 126 which interacts with a database 121 and an active directory service 127, an object storage module 128 working with an enterprise data depository 129, a security module 130 providing security and interfacing with public key infrastructure 131, and an archive module 132 working with a database 133 and an active directory service 134.

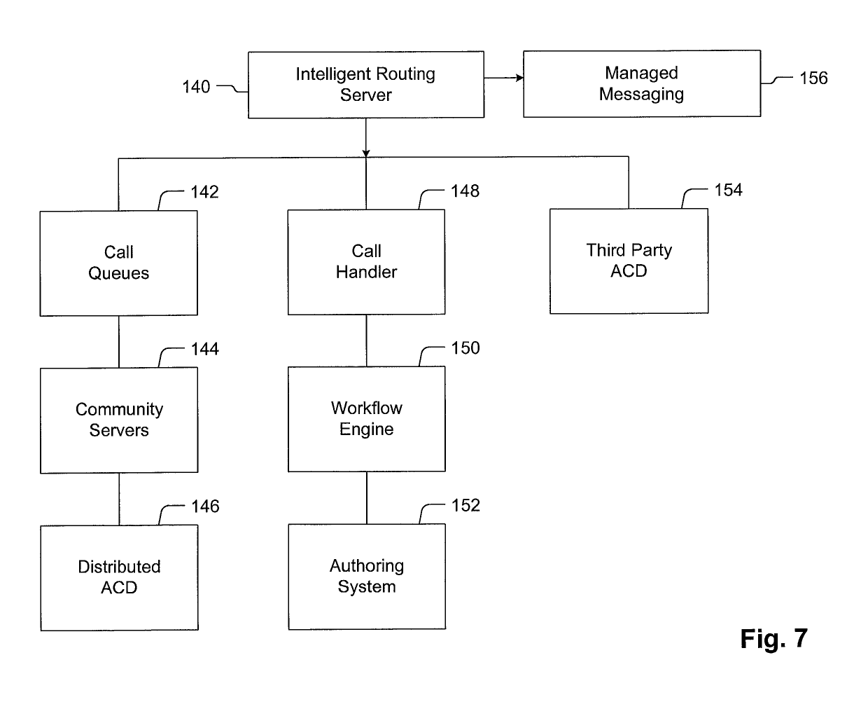

In routing the guests, referring to FIG. 7, an intelligent routing server 140 manages call queues 142, a call handler 148, and third party ACD 154. The call handler 148 interacts with community servers 144 and distributed ACD 146. The intelligent routing server 140 also provides managed messaging service 156.

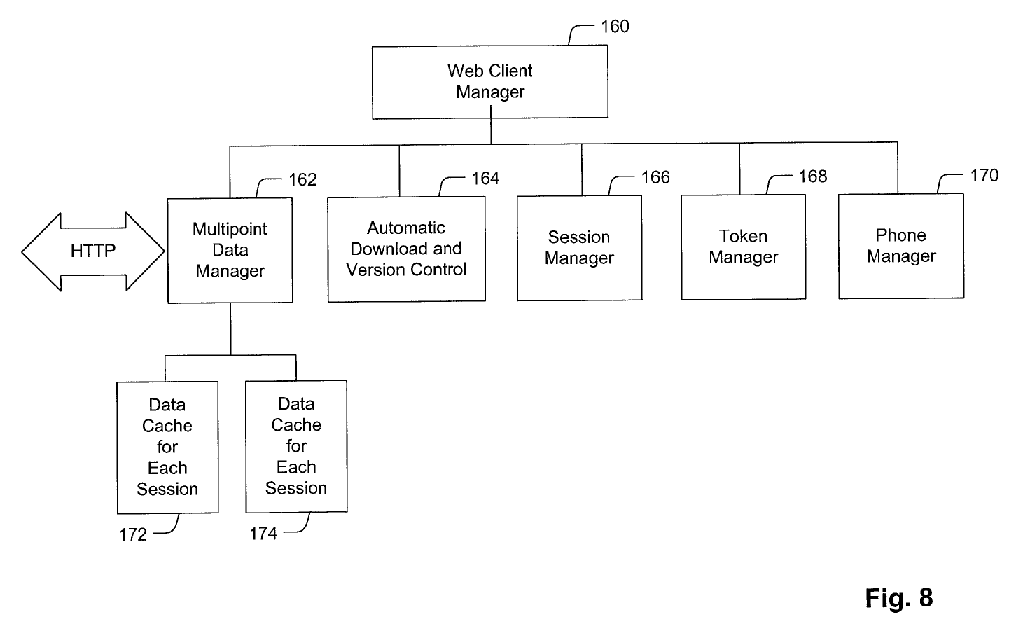

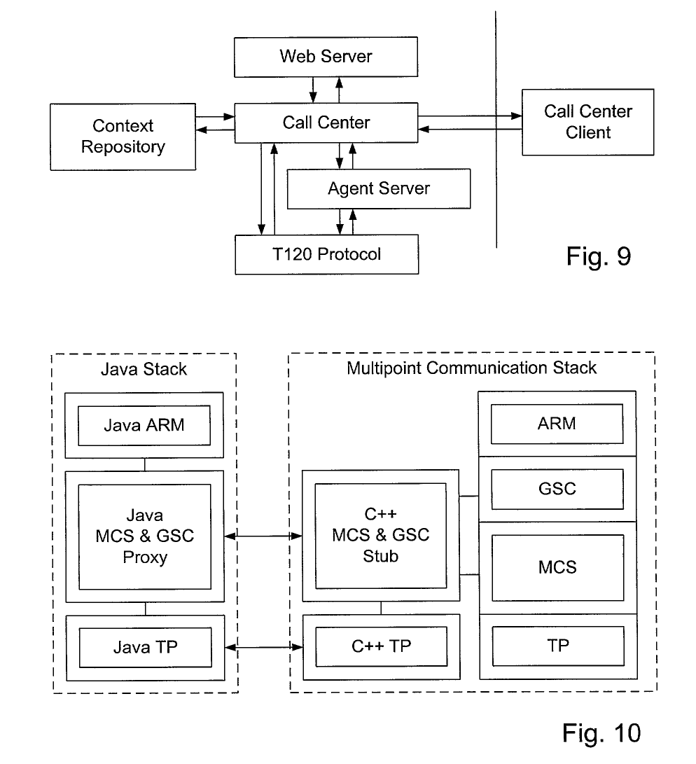

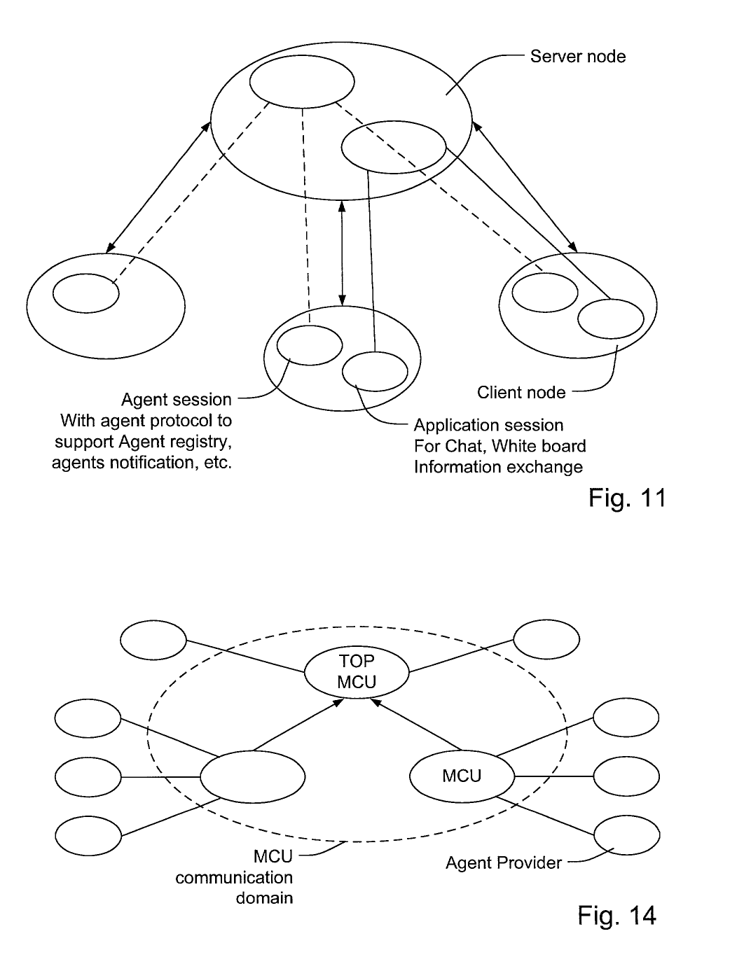

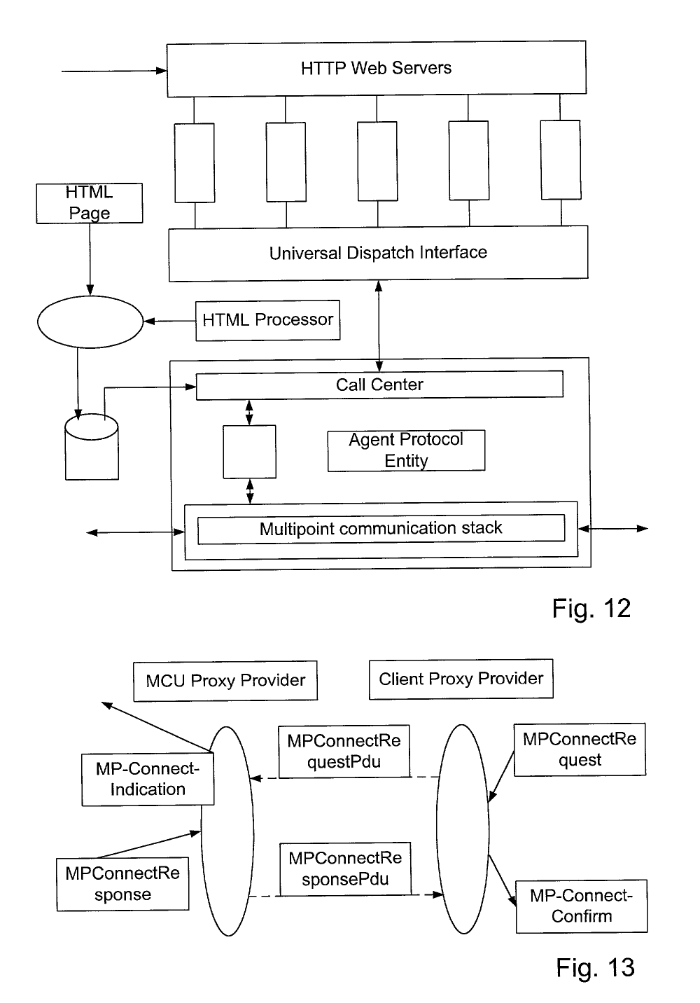

FIG. 8 illustrates a web client manager model where a web client manager 160 manages a multi-point data manager 162 (described above), automatic download and version control subsystem 164, a session manager 166, a token manager 168, and a phone manager 170. The multi-point data manager 162 manages the data cache for each session 172 and 174. The automatic download and version control subsystem controls the guest agents residing on the guest computers and the member agents residing on the member computers. The session manager 166 manages the sessions. The phone manager 170 manages the phone connections.

Appendix A further provides technical detail with respect to the above-described implementations. Appendix B further describes the features of the implementations. Both appendices are part of the implementations.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A computer program product, tangibly stored on a computer-readable medium, for establishing a conference over the Internet, comprising instructions operable to cause a programmable processor to:
a) provide on a web page a link for establishing a conference between two or more users;
b) link a browser running on a guest computer with a web server upon activation of the link by a guest using the guest computer;
c) assign a member for conferencing with the guest, the member having a member computer running a member browser; and
d) link the member browser with the web server for conferencing.

2. The computer program product of claim 1, further comprising instructions operable to cause a programmable processor to:
e) deliver collaboration software to the guest computer; wherein the guest browser and member browser conference using the collaboration software.

3. The computer program product of claim 2, wherein the collaboration software includes a text exchange tool, a whiteboard tool, and an application sharing tool.

4. The computer program product of claim 2, wherein the instructions operable to cause a programmable processor to assign comprise instructions operable to cause a programmable processor to:
gather information regarding the guest from the guest computer; and
select a member based on the information for conferencing.

5. The computer program product of claim 2, wherein the instructions operable to cause a programmable processor to assign comprise instructions operable to cause a programmable processor to:
receive a request from the guest to conference with a specific member; and
select the specific member for conferencing.

6. The computer program product of claim 2, wherein the conference is a real-time conference.

7. The computer program product of claim 6, wherein the collaboration software includes an Internet telephone, and wherein the instructions operable to cause a programmable processor to link comprise instructions operable to cause a programmable processor to:
establish an Internet phone connection between the guest browser and the member browser.

8. A computer program product as recited in claim 2, further comprising instructions operable to cause a programmable processor to:
encrypt communications between the guest and the member.

9. A computer program product for establishing a conference over the Internet, comprising instructions operable to cause a programmable processor to:
a) provide on a web page a link for establishing a conference between two or more users;
b) link a browser running on a guest computer with a web server upon activation of the link by a guest using the guest computer;
c) assign a member for conferencing with the guest; and
d) establish a telephone connection between the member and the guest.

10. A method for establishing a conference over the Internet, comprising:
a) providing on a web page a link for establishing a conference between two or more users;
b) linking a browser running on a guest computer with a web server upon activation of the link by a guest using the guest computer;
c) assigning a member for conferencing with the guest, the member having a member computer running a member browser; and
d) linking the member browser with the web server for conferencing.

11. The method of claim 10, further comprising:
e) delivering collaboration software to the guest computer; wherein the guest browser and member browser conference using the collaboration software.

12. The method of claim 11, wherein the collaboration software includes a text exchange tool, a whiteboard tool, and an application sharing tool.

13. The method of claim 11, wherein the assigning comprises:
gathering information regarding the guest from the guest computer; and
selecting a member based on the information for conferencing.

14. The method of claim 11, wherein the assigning comprises:
receiving a request from the guest to conference with a specific member; and
selecting the specific member for conferencing.

15. The method of claim 11, wherein the conference is a real-time conference.

16. The method of claim 15, wherein the collaboration software includes an Internet telephone, and the linking comprises:
establishing an Internet phone connection between the guest browser and the member browser.

17. A method as recited in claim 11, further comprising:
encrypting communications between the guest and the member.

18. A method for establishing a conference over the Internet, comprising:
a) providing on a web page a link for establishing a conference between two or more users;
b) linking a browser running on a guest computer with a web server upon activation of the link by a guest using the guest computer;
c) assigning a member for conferencing with the guest; and
d) establishing a telephone connection between the member and the guest.
